(19) United States
(12) Patent Application Publication
(10) Pub. No.: US 2026/0116149 A1
(43) Pub. Date: Apr. 30, 2026

(54) IN-VEHICLE DEVICE

(71) Applicant: TOYOTA JIDOSHA KABUSHIKI KAISHA, Toyota-shi (JP)

(72) Inventor: Mitsuaki HIGA, Toyota-shi (JP)

(73) Assignee: TOYOTA JIDOSHA KABUSHIKI KAISHA, Toyota-shi (JP)

(21) Appl. No.: 19/359,933

(22) Filed: Oct. 16, 2025

(30) Foreign Application Priority Data
Oct. 29, 2024 (JP) 2024-189764

(51) Int. Cl. B60H 1/00

(52) U.S. Cl. CPC B60H 1/00764; B60H 1/00821; B60H 1/00878

(57) ABSTRACT

A controller of an in-vehicle device limits an output of an air conditioner in accordance with acceleration of a vehicle that uses a common power supply source for traveling and air conditioning. The vehicle is capable of traveling in a manual driving mode and an autonomous driving mode by a driver. In a case where the vehicle is traveling in the autonomous driving mode, the limitation on the output of the air conditioner is relaxed compared to a case where the vehicle is traveling in the manual driving mode.

### CROSS-REFERENCE TO RELATED APPLICATION

This application claims priority to Japanese Patent Application No. 2024-189764 filed on October 29, 2024. The disclosure of the above-identified application, including the specification, drawings, and claims, is incorporated by reference herein in its entirety.

### BACKGROUND

### 1. Technical Field

The present disclosure relates to an in-vehicle device.

### 2. Description of Related Art

Japanese Unexamined Patent Application Publication No. 2019-214219 (JP 2019-214219 A) discloses a coordinate control device including a controller that performs coordination control for the driving force control of a driving source for traveling and air conditioning control of an air conditioning system including a compressor driven directly or indirectly by the driving source for traveling, and a coordination control method for the driving force control and the air conditioning control. In the coordination control method, whether there is an acceleration request is determined. In addition, in the coordination control method, whether there is a window defogging request of a windshield is determined. In the coordination control method, in a case where there is no window defogging request, air conditioning control that prioritizes power performance based on an acceleration request is performed. In addition, in the coordination control method, in a case where there is a window defogging request, air conditioning control that prioritizes window defogging performance based on the window defogging request over the power performance based on the acceleration request is performed.

### SUMMARY

An object of the present disclosure is to reduce discomfort of a user caused by a decrease in drivability of a vehicle and degradation of an air environment in the vehicle.

An in-vehicle device according to the present disclosure includes a controller configured to limit output of an air conditioner in accordance with acceleration of a vehicle that uses a power supply source that is common to traveling and air conditioning. The vehicle is configured to travel in a manual driving mode under control of a driver and an autonomous driving mode, and limitation on the output of the air conditioner is relaxed in a case where the vehicle is traveling in the autonomous driving mode, as compared with a case where the vehicle is traveling in the manual driving mode.

According to the present disclosure, it is possible to reduce discomfort of a user caused by a decrease in drivability of a vehicle and degradation of an air environment in the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a vehicle system;

FIG. 2 is a block diagram schematically showing an example of a functional configuration of an in-vehicle device;

FIG. 3 is a diagram showing an example of a table configuration of limitation information held in a limitation information database in a first embodiment;

FIG. 4 is a graph showing a correspondence between an air conditioning power and stop duration;

FIG. 5 is a flowchart of limitation processing executed by a controller; and

FIG. 6 is a diagram showing an example of a table configuration of limitation information held in a limitation information database in a second embodiment.

### DETAILED DESCRIPTION OF EMBODIMENTS

A vehicle that uses a common power supply source for traveling and air conditioning may accelerate. In this case, both the acceleration and the air conditioning may not be able to be achieved depending on an acceleration of the vehicle. In a case where an occupant drives the vehicle and the acceleration intended by the occupant is not achieved, it is assumed that the discomfort of the occupant increases due to the low drivability. Therefore, a controller of an in-vehicle device according to the present disclosure limits an output of an air conditioner in accordance with the acceleration of the vehicle. As a result, it is possible to suppress a decrease in drivability.

However, in a case where the output of the air conditioner is limited in a situation in which an air environment in the vehicle is bad, it is assumed that the air environment in the vehicle further deteriorates. In this case, the discomfort occurs in the occupant of the vehicle due to the deterioration of the air environment in the vehicle. On the other hand, in a case where the vehicle is traveling in an autonomous driving mode, the acceleration of the vehicle is performed automatically or with driving assistance. Therefore, in a case where the vehicle is traveling in the autonomous driving mode, a demand for drivability is smaller than that in a case where the occupant drives the vehicle (in a case where the vehicle is traveling in a manual driving mode by a driver). Therefore, in a case where the vehicle is traveling in the autonomous driving mode, even in a case where the air conditioning is prioritized over the acceleration, the discomfort of the occupant with respect to the drivability is unlikely to occur. Therefore, in a case where the vehicle is traveling in the autonomous driving mode, the limitation on the output of the air conditioner is relaxed compared to a case where the vehicle is traveling in the manual driving mode.

As described above, the in-vehicle device relaxes the limitation on the output of the air conditioner in a case where the vehicle is traveling by autonomous driving. As a result, the air conditioning is prioritized over the acceleration in a case where the demand for the drivability is smaller than that in a case where the occupant drives the vehicle. As a result, it is possible to suppress the deterioration of the environment in the vehicle. In addition, in a case where the vehicle is traveling in the manual driving mode, the acceleration of the vehicle is prioritized by limiting the output of the air conditioner without relaxing the limitation. Therefore, in a case where the vehicle is traveling in the manual driving mode, the drivability can be prioritized over the air conditioning. As a result, it is possible to suppress the discomfort of the user caused by the decrease in the drivability of the vehicle and the deterioration of the air environment in the vehicle.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure.

### First Embodiment

### Schematic of System

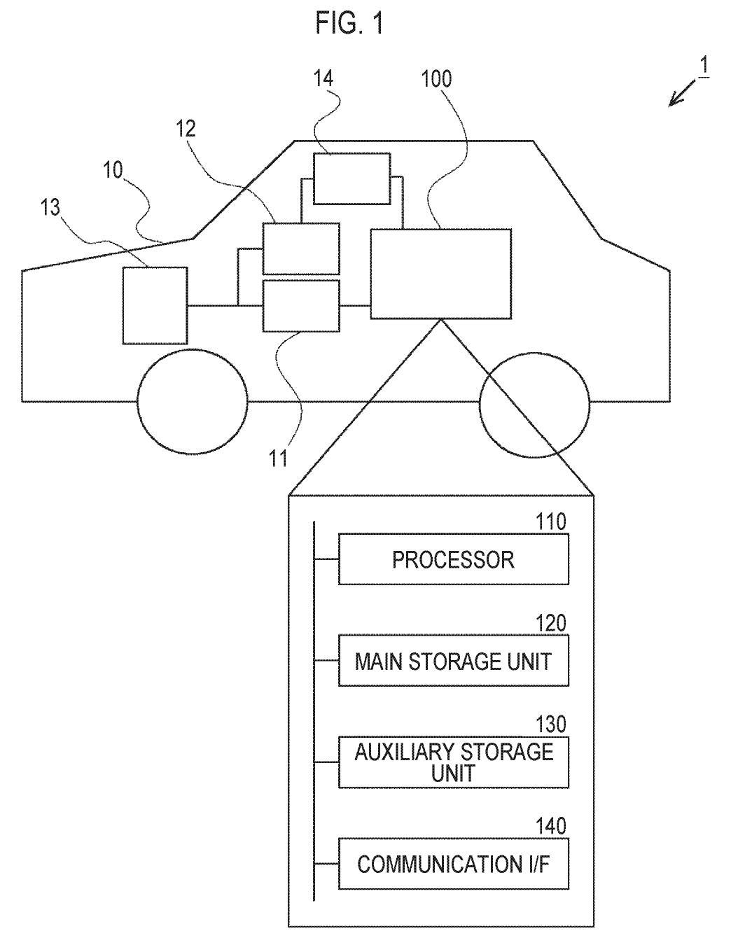

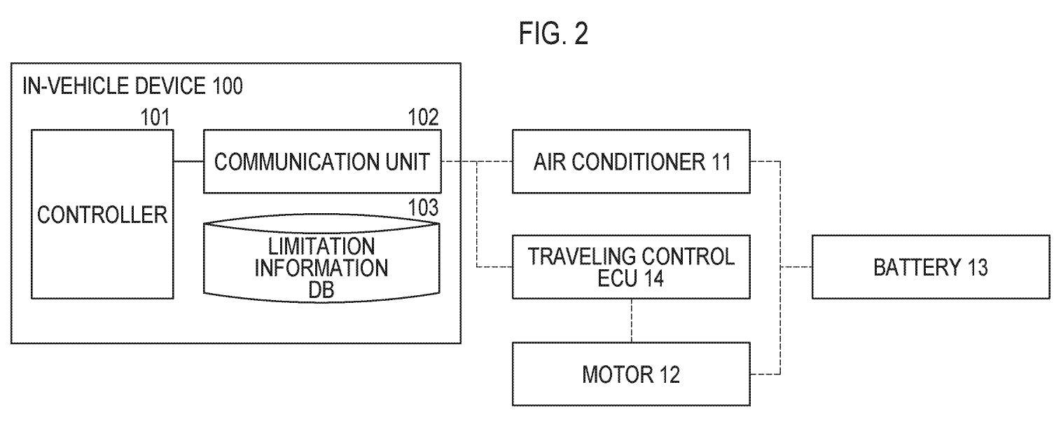

A vehicle system 1 according to the present embodiment will be described with reference to FIGS. 1 and 2. FIG. 1 is a diagram showing a schematic configuration of the vehicle system 1. The vehicle system 1 is configured to include an air conditioner 11, a motor 12, a battery 13, a traveling control ECU 14, and an in-vehicle device 100 mounted on a vehicle 10. In the embodiment, the vehicle 10 is a battery electric vehicle.

In the vehicle system 1, the air conditioner 11, the motor 12, the battery 13, the traveling control ECU 14, and the in-vehicle device 100 are connected by an in-vehicle network. In the present embodiment, the in-vehicle device 100 is connected to the air conditioner 11 and the traveling control ECU 14 by the in-vehicle network. The traveling control ECU 14 is connected to the motor 12 by the in-vehicle network. The battery 13 is connected to the air conditioner 11 and the motor 12 by the in-vehicle network. In the vehicle system 1, the air conditioner 11, the motor 12, the battery 13, the traveling control ECU 14, and the in-vehicle device 100 may be connected to each other via the in-vehicle network.

### Battery

The battery 13 is a battery that supplies power for traveling of the vehicle 10. The battery 13 supplies the power for traveling of the vehicle 10 by being electrically connected to the motor 12. The battery 13 is a battery that supplies power for air conditioning in the vehicle 10. The battery 13 supplies the power for air conditioning in the vehicle 10 by being electrically connected to the air conditioner 11. That is, the battery 13 is a common power supply source for the traveling and the air conditioning of the vehicle 10.

### Air Conditioner

The air conditioner 11 is a device that adjusts an air environment in the vehicle 10. The air conditioner 11 adjusts a temperature in the vehicle 10. The air conditioner 11 may perform ventilation and dehumidification in the vehicle 10.

### Motor

The motor 12 is an electric motor that generates a driving force for traveling of the vehicle 10. The motor 12 causes the vehicle 10 to travel by receiving the supply of power from the battery 13.

### Traveling Control ECU

The traveling control ECU 14 is an electronic control unit (ECU) for controlling the traveling of the vehicle 10. Here, the vehicle 10 is a vehicle having two types of traveling modes of a manual driving mode in which the vehicle 10 travels in response to an operation of the driver and an autonomous driving mode. The traveling control ECU 14 transmits an electric signal for traveling control to the motor 12 via the in-vehicle network in response to the operation of the driver of the vehicle 10 in a case where the vehicle 10 is traveling in the manual driving mode. Here, the electric signal for the traveling control is a signal for indicating an output of the motor 12.

In addition, in a case where the vehicle 10 is traveling in the autonomous driving mode, the traveling control ECU 14 performs control of the autonomous driving of the vehicle 10. The traveling control ECU 14 performs the control of the autonomous driving in accordance with a sensing value of a sensor provided in the vehicle 10. The traveling control ECU 14 performs the control of the autonomous driving in accordance with, for example, a moving image captured by a camera provided in the vehicle 10. Then, the traveling control ECU 14 transmits an electric signal for autonomous driving control to the motor 12 via the in-vehicle network. Here, the electric signal for the autonomous driving control is a signal for indicating the output of the motor 12.

The traveling control ECU 14 produces acceleration information related to the acceleration of the vehicle 10 in a case where the vehicle 10 is accelerated. Here, the acceleration information includes information indicating an acceleration of the vehicle 10 and an acceleration time of the vehicle 10. The traveling control ECU 14 transmits the acceleration information to the in-vehicle device 100 via the in-vehicle network.

### In-Vehicle Device

The in-vehicle device 100 is a device that controls the air conditioning of the vehicle 10. Here, in a case where the vehicle 10 is accelerated, since the air conditioner 11 and the motor 12 use a common power supply source, both the acceleration and the air conditioning may not be achieved depending on the acceleration required for the vehicle 10.

A case is assumed in which a driver of the vehicle 10 (hereinafter, simply referred to as a "driver") performs an accelerator operation. In this case, in a case where the acceleration intended by the driver is not achieved, it is assumed that the discomfort of the driver increases due to the low drivability. Therefore, the in-vehicle device 100 limits the output of the air conditioner in accordance with the acceleration of the vehicle.

Here, it is assumed that the output of the air conditioner 11 is uniformly limited in a case where both the acceleration and the air conditioning cannot be achieved. In this case, in a case where the output of the air conditioner 11 is limited in a state in which the air environment in the vehicle 10 is bad, it is assumed that the air environment in the vehicle 10 further deteriorates. In this case, the discomfort of the occupant of the vehicle 10 occurs due to the deterioration of the air environment in the vehicle 10.

On the other hand, in a case where the vehicle 10 is performing autonomous driving, the traveling control ECU 14 may make the acceleration request. In this case, even in a case where the acceleration is insufficient, the driver does not drive the vehicle, and thus it is assumed that the discomfort is less likely to occur than in a case where the driver drives the vehicle 10. Therefore, in a case where the vehicle 10 is performing autonomous driving, even in a case where the air conditioning is prioritized over the acceleration, the discomfort of the occupant with respect to the drivability is unlikely to occur. Therefore, in a case where the vehicle 10 is traveling in the autonomous driving mode, the in-vehicle device 100 relaxes the limitation on the output of the air conditioner 11 compared to a case where the vehicle 10 is traveling in the manual driving mode. In this case, the acceleration need not be performed as requested by the acceleration request from the traveling control ECU 14. Details of a method in which the in-vehicle device 100 relaxes the limitation on the output of the air conditioner 11 will be described later.

The in-vehicle device 100 includes a computer including a processor 110, a main storage unit 120, an auxiliary storage unit 130, and a communication interface (communication I/F) 140. The processor 110 is, for example, a central processing unit (CPU) or a digital signal processor (DSP). The main storage unit 120 is, for example, a random-access memory (RAM). The auxiliary storage unit 130 is, for example, a read-only memory (ROM). The auxiliary storage unit 130 is, for example, a hard disk drive (HDD) or a disk recording medium such as a CD-ROM, a DVD disk, or a blue ray disk. The auxiliary storage unit 130 may be a removable medium (portable storage medium). Here, examples of the removable medium include a USB memory and an SD card. The communication I/F 140 is, for example, a local area network (LAN) interface board or a wireless communication circuit for wireless communication.

In the in-vehicle device 100, the auxiliary storage unit 130 stores an operating system (OS), various programs, various information tables, and the like. In addition, in the in-vehicle device 100, the processor 110 can implement various functions as described below by loading the program stored in the auxiliary storage unit 130 into the main storage unit 120 and executing the program. Some or all of the functions of the in-vehicle device 100 may be implemented by a hardware circuit such as an ASIC or an FPGA. The in-vehicle device 100 is not necessarily required to be implemented by a single physical configuration, and may be configured by a plurality of computers that cooperate with each other. In addition, the air conditioner 11, the motor 12, the battery 13, and the traveling control ECU 14 are also configured to include a computer similarly to the in-vehicle device 100.

### Functional Configuration

Next, a functional configuration of the in-vehicle device 100 constituting the vehicle system 1 will be described with reference to FIGS. 2 to 4. FIG. 2 is a block diagram schematically showing an example of the functional configuration of the in-vehicle device 100. The in-vehicle device 100 is configured to include a controller 101, a communication unit 102, and a limitation information DB 103. The controller 101 has a function of performing arithmetic processing for controlling the in-vehicle device 100. The controller 101 can be implemented by the processor 110 in the in-vehicle device 100. The communication unit 102 has a function of connecting the in-vehicle device 100 to the in-vehicle network. The communication unit 102 can be implemented by the communication I/F 140 in the in-vehicle device 100.

The controller 101 receives the acceleration information from the traveling control ECU 14 via the communication unit 102. The controller 101 calculates power required to achieve the instructed acceleration (hereinafter, may be referred to as "acceleration power") by referring to the acceleration information received from the traveling control ECU 14. In addition, the controller 101 receives output amount information indicating a current output amount of the air conditioner 11 from the air conditioner 11 via the communication unit 102. Here, the output amount is, for example, a set temperature and an air blowing amount. The controller 101 calculates power required for the air conditioning of the vehicle 10 (hereinafter, may be referred to as "air conditioning power") by referring to the output amount information received from the air conditioner 11.

The controller 101 determines whether the calculated acceleration power and air conditioning power exceed power (hereinafter, may be referred to as "suppliable power") that can be supplied at the same time to the air conditioner 11 and the motor 12 by the battery 13. Here, the suppliable power is determined by the power that can be output by the battery 13. The suppliable power is a predetermined amount of power. In addition, the suppliable power may be different depending on an electric amount of the battery 13, a temperature, or the like. In this case, the controller 101 may acquire the suppliable power from the battery 13. In addition, in a case where the battery 13 supplies power to a device other than the air conditioner 11 and the motor 12, the controller 101 determines whether the sum of the acceleration power, the air conditioning power, and the used power of the device exceeds the suppliable power.

In a case where a determination is made that the acceleration power and the air conditioning power exceed the suppliable power, the controller 101 acquires traveling mode information indicating the traveling mode of the vehicle 10 from the traveling control ECU 14 via the communication unit 102. The traveling mode information includes information indicating whether the vehicle 10 is traveling in the manual driving mode or the autonomous driving mode.

The controller 101 specifies the traveling mode of the vehicle 10 by referring to the acquired traveling mode information. The controller 101 determines the stop duration as a basic stop duration in a case where the traveling mode of the vehicle 10 is the manual driving mode. Here, the basic stop duration is a time in which it is determined that the acceleration can be sufficiently achieved by stopping the output of the air conditioner 11. The basic stop duration is a predetermined stop duration. The controller 101 outputs, to the air conditioner 11 via the communication unit 102, stop instruction information for an instruction for instructing the air conditioner 11 to stop the output for the basic stop duration. As a result, the air conditioner 11 can stop the output for the basic stop duration.

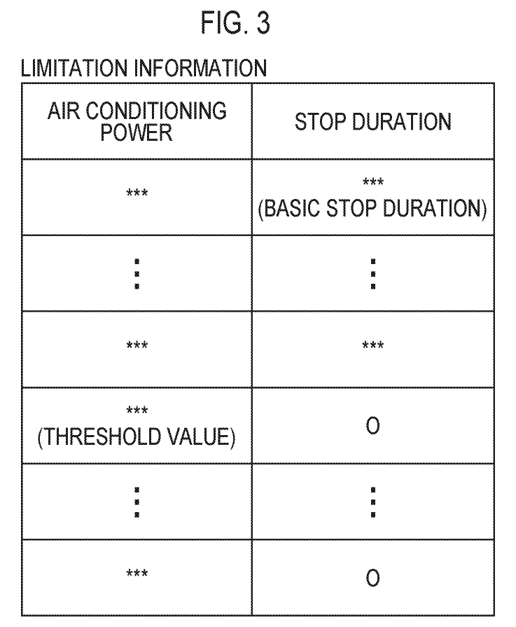

In addition, in a case where the vehicle 10 is traveling in the autonomous driving mode, the controller 101 determines the stop duration of the output of the air conditioner 11 (hereinafter, simply referred to as a "stop duration") by referring to the limitation information. The limitation information is information indicating a limitation content of the output of the air conditioner 11. The limitation information DB 103 has a function of holding the limitation information. The limitation information DB 103 can be implemented by the auxiliary storage unit 130 in the in-vehicle device 100. FIG. 3 is a diagram showing an example of a table configuration of the limitation information held in the limitation information DB 103 in the present embodiment.

As shown in FIG. 3, the limitation information has an air conditioning power field and stop duration field. Information indicating the air conditioning power of the air conditioner 11 is stored in the air conditioning power field. Information indicating lower air conditioning power is stored in the air conditioning power field in order from the top. In addition, the stop duration field stores information indicating stop duration corresponding to the air conditioning power indicated in the corresponding air conditioning power field. The stop duration field stores, for example, information indicating the number of seconds of the stop duration.

Here, the output of the air conditioner 11 may be increased due to the bad air environment in the vehicle 10. In this case, in a case where the output of the air conditioner 11 is stopped for a long time, it is assumed that the air environment in the vehicle 10 further deteriorates than in a case where the output of the air conditioner 11 is stopped for a short time. Therefore, in a case where the air conditioning power is large, the deterioration of the air environment in the vehicle 10 can be suppressed by making the stop duration shorter than in a case where the air conditioning power is small. Therefore, information indicating longer stop durations is stored in the stop duration field in order from the top. In the present embodiment, in a case where the air conditioning power is the minimum, the basic stop duration is set as the stop duration. In a case where the air conditioning power is the minimum, a predetermined time shorter than the basic stop duration may be set as the stop duration.

In addition, the air conditioning power equal to or greater than a threshold value may be used by increasing the output in order to quickly improve the air environment of the air conditioner 11. Here, the threshold value is the air conditioning power determined to be necessary in order to quickly improve the air environment of the air conditioner 11. In this case, in a case where the output of the air conditioner 11 is stopped, it is assumed that the air environment in the vehicle 10 further deteriorates than in a case where the air conditioning power less than the threshold value is used. Therefore, in the stop duration field, information indicating "0" is stored in a case where the air conditioning power is equal to or greater than the threshold value. That is, in the stop duration field, in a case where the air conditioning power is equal to or greater than the threshold value, information indicating that the stop duration of the output of the air conditioner 11 is set to zero and the stop of the output of the air conditioner 11 is prohibited is stored.

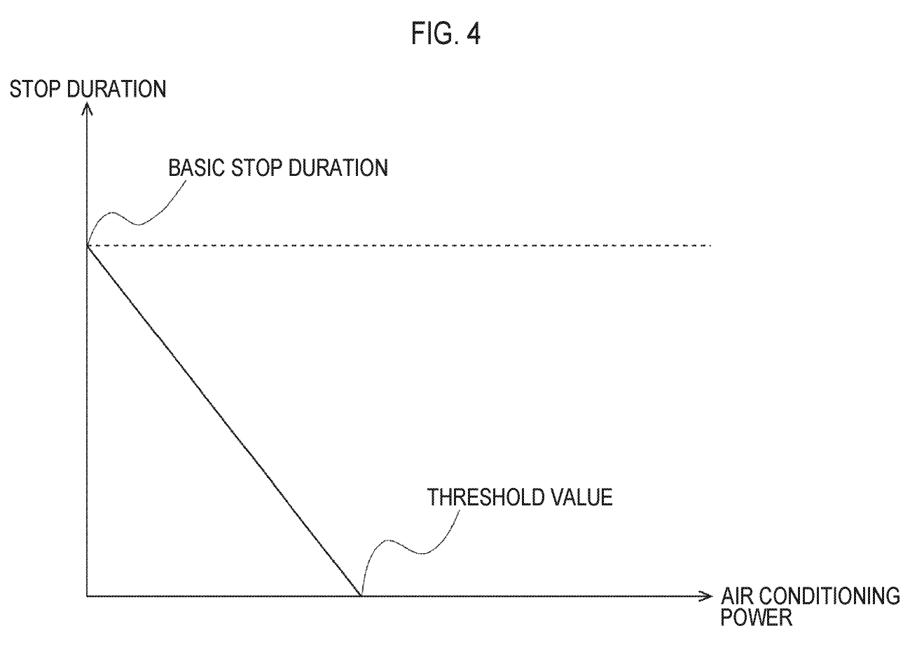

FIG. 4 is a graph showing a correspondence between the air conditioning power and the stop duration. A horizontal axis of the graph shown in FIG. 4 (hereinafter, may be simply referred to as a "horizontal axis of the graph") indicates the magnitude of the air conditioning power. In the horizontal axis of the graph, the air conditioning power is larger as the position is closer to the right side. A vertical axis of the graph shown in FIG. 4 (hereinafter, may be simply referred to as a "vertical axis of the graph") indicates the stop duration. In the vertical axis of the graph, the stop duration is longer as the position is higher. In addition, an origin of the graph shown in FIG. 4 indicates the minimum air conditioning power of the air conditioner 11 and the stop duration of zero. In addition, in FIG. 4, the stop duration in a case where the vehicle 10 is traveling in the autonomous driving mode is indicated by a solid line. In addition, in FIG. 4, the stop duration in a case where the vehicle 10 is traveling in the manual driving mode is indicated by a broken line.

As shown in FIG. 4, in a case where the vehicle 10 is traveling in the manual driving mode, the basic stop duration is the stop duration regardless of the air conditioning power. In addition, as shown in FIG. 4, in a case where the vehicle 10 is traveling in the autonomous driving mode, the basic stop duration is the stop duration at a minimum value on the horizontal axis of the graph (minimum air conditioning power of the air conditioner 11). In addition, the stop duration is monotonically decreased from the minimum value on the horizontal axis of the graph to the threshold value. In addition, the stop duration is zero in the air conditioning power equal to or greater than the threshold value on the horizontal axis of the graph. In this way, in a case where the vehicle 10 is traveling in the autonomous driving mode, a shorter stop duration is set than in a case where the vehicle 10 is traveling in the manual driving mode. That is, in a case where the vehicle 10 is traveling in the autonomous driving mode, the limitation on the output of the air conditioner 11 is relaxed compared to a case where the vehicle 10 is traveling in the manual driving mode.

In addition, in a case where the air conditioning power is large, it is assumed that the output (output amount) of the air conditioner 11 is large. Therefore, in a case where the vehicle 10 is traveling in the autonomous driving mode, the stop duration is set to be shorter as the output of the air conditioner 11 is larger. In addition, in a case where the output of the air conditioner 11 exceeds the threshold value in a case where the vehicle 10 is traveling in the autonomous driving mode, the stop duration is zero.

In a case where the traveling mode of the vehicle 10 is the autonomous driving mode, the controller 101 specifies the stop duration field corresponding to the calculated air conditioning power by referring to the limitation information, and determines the stop duration from the information indicating the stop duration stored in the stop duration field. In this case, the controller 101 determines whether the determined stop duration is larger than zero. In a case where the stop duration is larger than zero, the controller 101 outputs, to the air conditioner 11 via the communication unit 102, the stop instruction information for an instruction for instructing the air conditioner 11 to stop the output for the determined stop duration. As a result, the air conditioner 11 can stop the output for the stop duration.

### Limitation Processing

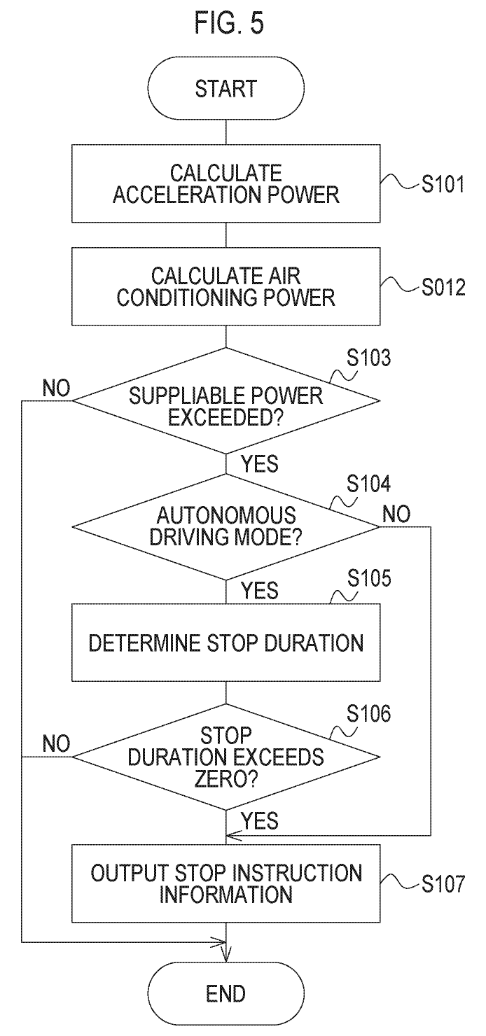

Next, in the vehicle system 1, limitation processing executed by the controller 101 in the in-vehicle device 100 will be described with reference to FIG. 5. FIG. 5 is a flowchart of the limitation processing executed by the controller 101. The limitation processing is processing for limiting (stopping) the output of the air conditioner 11 according to whether the acceleration power and the air conditioning power exceed the suppliable power. The limitation processing is repeatedly started at a predetermined interval.

In the limitation processing, first, in S101, the acceleration power corresponding to the acceleration information received from the traveling control ECU 14 is calculated. In addition, in S102, the air conditioning power corresponding to the output amount information received from the air conditioner 11 is calculated. Next, in S103, it is determined whether the sum of the calculated acceleration power and air conditioning power exceeds the suppliable power. In a case where a negative determination is made in S103, the acceleration can be performed as requested by the acceleration request even in a case where the output of the air conditioner 11 is not limited. Therefore, the limitation processing is temporarily ended.

In a case where an affirmative determination is made in S103, in S104, the traveling mode information acquired from the traveling control ECU 14 is referred to, and it is determined whether the traveling mode of the vehicle 10 is the autonomous driving mode. In a case where a negative determination is made in S104, the vehicle 10 is traveling in the manual driving mode. Therefore, in order to prioritize the drivability, the stop instruction information for stopping the output for the basic stop duration is output to the air conditioner 11 in S107.

Here, in the present embodiment, an affirmative determination is made in a case where the sum of the acceleration power and the air conditioning power exceeds the suppliable power, and a negative determination is made in a case where the sum of the acceleration power and the air conditioning power is less than the suppliable power. In a case where the sum of the acceleration power and the air conditioning power is equal to the suppliable power, either the affirmative determination or the negative determination may be made.

In a case where an affirmative determination is made in S104, in S105, the limitation information held in the limitation information DB 103 is referred to, and the stop duration corresponding to the air conditioning power is determined. Next, in S106, it is determined whether the stop duration exceeds zero. In a case where a negative determination is made in S106, the stop duration is zero, and thus it is not necessary to stop the output of the air conditioner 11. Therefore, the limitation processing is temporarily ended. In this way, in a case where the air conditioning power (output of the air conditioner 11) is equal to or greater than the threshold value, the controller 101 prohibits the stop of the output of the air conditioner 11.

In a case where an affirmative determination is made in S106, the output of the air conditioner 11 is stopped for the stop duration, and thus the stop instruction information is output to the air conditioner 11 in S107. Here, the stop instruction information output in S107 is information for an instruction to stop the output for the stop duration determined in the processing of S105. Then, the limitation processing is temporarily ended.

As described above, in the vehicle system 1, in a case where the vehicle 10 is traveling in the autonomous driving mode, the stop duration of the output of the air conditioner 11 is shorter than that in a case where the vehicle 10 is traveling in the manual driving mode. That is, in a case where the vehicle 10 is traveling in the autonomous driving mode, the limitation on the output of the air conditioner 11 is relaxed compared to a case where the vehicle 10 is traveling in the manual driving mode. As a result, the air conditioning is prioritized over the acceleration in a case where the demand for the drivability is smaller than that in a case where the vehicle 10 is traveling in the manual driving mode.

In addition, in a case where the air conditioning power is large, the stop duration is shorter than that in a case where the air conditioning power is small. Therefore, in a case where the output of the air conditioner 11 is increased due to the bad air environment in the vehicle 10, it is possible to suppress the deterioration of the air environment in the vehicle 10. In addition, in this case, in a case where the air conditioning power equal to or greater than the threshold value is used in order to quickly improve the air environment of the air conditioner 11, the stop of the output of the air conditioner 11 is prohibited. As a result, it is possible to suppress the deterioration of the air environment in the vehicle 10 in a case where the air conditioning power equal to or greater than the threshold value is used in order to quickly improve the air environment of the air conditioner 11. In addition, in a case where the vehicle 10 is traveling in the manual driving mode, the output for the basic stop duration is stopped. Therefore, in a case where the vehicle 10 is traveling in the manual driving mode, the drivability can be prioritized over the air conditioning. In this way, it is possible to suppress the discomfort of the user caused by the decrease in the drivability of the vehicle 10 and the deterioration of the air environment in the vehicle 10.

### Second Embodiment

In the first embodiment, the in-vehicle device 100 limits the output of the air conditioner 11 by stopping the air conditioner 11. On the other hand, in the present embodiment, the in-vehicle device 100 limits the output of the air conditioner 11 by limiting the output amount of the air conditioner 11. Here, the limitation of the output amount of the air conditioner 11 is, for example, to limit the set temperature or the air blowing amount. The limitation of the set temperature is to increase or decrease the set temperature in a case where the air conditioner 11 is in an air conditioning mode or a heating mode, respectively. In addition, the limitation of the set temperature is to decrease a ventilation amount in a case where the air conditioner 11 is in a ventilation mode, and to limit a dehumidifying ability in a case where the air conditioner 11 is in a dehumidifying mode. Hereinafter, only points different from the first embodiment will be described.

### Functional Configuration

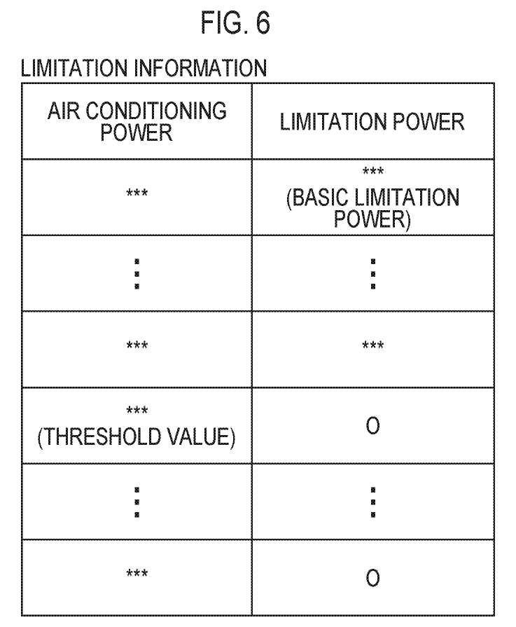

FIG. 6 is a diagram showing an example of a table configuration of the limitation information held in the limitation information DB 103 in the present embodiment. The limitation information held in the limitation information DB 103 has an air conditioning power field and a limitation power field. As in the first embodiment, the information indicating lower air conditioning power is stored in the air conditioning power field in order from the top. The limitation power field stores information indicating the limitation power corresponding to the air conditioning power indicated in the corresponding air conditioning power field. Here, the limitation power is power limited from the air conditioning power. That is, a value obtained by subtracting the limitation power from the air conditioning power is the air conditioning power after the limitation.

Here, the output of the air conditioner 11 may be increased due to the bad air environment in the vehicle 10. In this case, in a case where the output amount of the air conditioner 11 is largely limited, it is assumed that the air environment in the vehicle 10 deteriorates compared to a case where the output amount of the air conditioner 11 is slightly limited. Therefore, in a case where the air conditioning power is large, the amount of limitation power is smaller than that in a case where the air conditioning power is small. As a result, the decrease in the air conditioning power is small, and the limitation of the output amount of the air conditioner 11 is small. Therefore, information indicating larger limitation powers is stored in the limitation power field in order from the top. As a result, it is possible to suppress the deterioration of the air environment in the vehicle 10.

In addition, in this case, the air conditioning power equal to or greater than the threshold value may be used in order to quickly improve the air environment of the air conditioner 11. In this case, in a case where the output amount of the air conditioner 11 is limited, it is assumed that the air environment in the vehicle 10 deteriorates. Therefore, in the stop duration field, information indicating "0" is stored in a case where the air conditioning power is equal to or greater than the threshold value. That is, in the limitation power field, in a case where the air conditioning power is equal to or greater than the threshold value, information indicating that the limitation power is set to zero (limitation of the air conditioning power is not performed) is stored.

The controller 101 determines the limitation power of the air conditioner 11 by referring to the limitation information held in the limitation information DB 103 and the calculated air conditioning power. That is, the controller 101 specifies the limitation power field corresponding to the calculated air conditioning power by referring to the limitation information, and determines the limitation power from the information indicating the limitation power stored in the limitation power field. Then, the controller 101 outputs output instruction information for an instruction to output the power based on the air conditioning power after the limitation to the air conditioner 11 via the communication unit 102. In this way, the controller 101 limits the output amount of the air conditioner 11 according to the limitation power. Here, the output instruction information may include information indicating a time at which the limitation of the output amount of the air conditioner 11 is performed. The time at which the limitation of the output amount of the air conditioner 11 is performed is a predetermined time. The time at which the limitation of the output amount of the air conditioner 11 is performed may be a time at which the vehicle 10 is accelerated. In this way, the controller 101 limits the output amount of the air conditioner 11.

In addition, the controller 101 limits the air conditioning power with basic limitation power in a case where the vehicle 10 is traveling in the manual driving mode. Here, the basic limitation power is the limitation power assumed to be sufficient for acceleration. The basic limitation power is limitation power corresponding to the minimum air conditioning power of the air conditioner 11. The basic limitation power may be the limitation power larger than the minimum air conditioning power of the air conditioner 11.

The controller 101 executes the limitation processing. In this case, the limitation power is determined according to the limitation information held in the limitation information DB 103 and the limitation power instead of the processing of S105 in FIG. 5. In addition, the controller 101 determines whether the limitation power exceeds zero, instead of the processing of S106 in FIG. 5. Here, in a case where a negative determination is made in S106 (in a case where the limitation power is zero), the limitation processing is ended because the limitation of the air conditioning power need not be performed. In this way, the controller 101 prohibits the limitation of the output amount of the air conditioner 11. In addition, in a case where an affirmative determination is made in S106, the output instruction information is output to the air conditioner 11, instead of the processing of S107 in FIG. 5. In addition, in S107 executed after the negative determination is made in the processing of S104 in FIG. 5, the output instruction information for an instruction to output the air conditioning power after the limitation with the basic limitation power is output.

As described above, in the vehicle system 1, in a case where the vehicle 10 is traveling in the autonomous driving mode, the limitation on the output amount of the air conditioner 11 is relaxed compared to a case where the vehicle 10 is traveling in the manual driving mode. As a result, the air conditioning is prioritized over the acceleration in a case where the demand for the drivability is smaller than that in a case where the vehicle 10 is traveling in the manual driving mode.

In addition, in a case where the air conditioning power is large, the amount of limitation power is smaller than that in a case where the air conditioning power is small. Therefore, in a case where the output of the air conditioner 11 is increased due to the bad air environment in the vehicle 10, it is possible to suppress the deterioration of the air environment in the vehicle 10. In addition, in this case, in a case where the air conditioning power equal to or greater than the threshold value is used in order to quickly improve the air environment of the air conditioner 11, the limitation of the output amount of the air conditioner 11 is prohibited. As a result, it is possible to suppress the deterioration of the air environment in the vehicle 10 in a case where the air conditioning power equal to or greater than the threshold value is used in order to quickly improve the air environment of the air conditioner 11. In this way, it is possible to suppress the discomfort of the user caused by the decrease in the drivability of the vehicle 10 and the deterioration of the air environment in the vehicle.

### Modification 1

In the first embodiment and the second embodiment, the vehicle 10 is a battery electric vehicle. However, the vehicle 10 does not necessarily have to be a battery electric vehicle as long as it is a vehicle that uses a common power supply source for traveling and air conditioning. For example, a hybrid electric vehicle accelerates by generating a driving force with both an engine and an electric motor. In this case, during acceleration of the hybrid electric vehicle, the acceleration power and the air conditioning power used by the electric motor may exceed the suppliable power. Therefore, the vehicle 10 may be a hybrid electric vehicle.

### Modification 2

In the first embodiment and the second embodiment, the vehicle 10 is a vehicle having two types of traveling modes of the manual driving mode and the autonomous driving mode. Here, a case is assumed in which the vehicle 10 is traveling in a driving assistance mode in which a part of a driving operation is assisted. The driving assistance mode is, for example, a cruise control mode in which a distance between vehicles is controlled. In this case, since the acceleration of the vehicle 10 is performed fully automatically or semi-automatically, even in a case where the acceleration of the vehicle 10 is insufficient and the drivability is decreased, it is assumed that the discomfort of the driver is less than that in a case where the vehicle 10 is traveling in the manual driving mode. Therefore, even in a case where the limitation on the output of the air conditioner 11 is relaxed in a case where the vehicle 10 is traveling in the cruise control mode other than the autonomous driving mode, the discomfort of the driver with respect to the drivability is unlikely to occur. Therefore, the in-vehicle device 100 may relax the limitation on the output of the air conditioner 11 in a case where the vehicle 10 is semi-automatically traveling, in addition to a case where the vehicle 10 is traveling in the autonomous driving mode. In this way, even in a case where the limitation on the output of the air conditioner 11 is relaxed in a case where the vehicle 10 is performing autonomous driving in any manner, it is possible to suppress the discomfort of the user caused by the decrease in the drivability of the vehicle 10 and the deterioration of the air environment in the vehicle 10.

### Other Embodiments

The above embodiment is merely an example, and the present disclosure may be implemented with appropriate modifications without departing from the gist thereof. In addition, the processing and means described in the present disclosure can be implemented in any combination as long as no technical inconsistencies arise.

The processing described as being performed by one device may be executed by a plurality of devices in a shared manner. Alternatively, processing described as being performed by different devices may be executed by one device. In a computer system, a hardware configuration (server configuration) for realizing each function can be flexibly changed.

The present disclosure can also be realized by supplying a computer program in which the functions described in the above embodiment are implemented to a computer, and reading and executing the program by one or more processors possessed by the computer. Such a computer program may be provided to the computer by a non-transitory computer-readable storage medium that can be connected to the computer's system bus, or may be provided to the computer via a network. The non-transitory computer-readable storage medium includes, for example, any type of disk such as a magnetic disk (a floppy (registered trademark) disk or a hard disk drive (HDD)) or an optical disk (a CD-ROM, a DVD disk, or a blue ray disk), a read-only memory (ROM), a random-access memory (RAM), an EPROM, an EEPROM, a magnetic card, a flash memory, or any type of medium such as an optical card suitable for storing electronic commands.

What is claimed is:

1. An in-vehicle device comprising a controller configured to limit output of an air conditioner in accordance with acceleration of a vehicle that uses a power supply source that is common to traveling and air conditioning, wherein:
the vehicle is configured to travel in a manual driving mode under control of a driver and an autonomous driving mode; and
limitation on the output of the air conditioner is relaxed in a case where the vehicle is traveling in the autonomous driving mode, as compared with a case where the vehicle is traveling in the manual driving mode.

2. The in-vehicle device according to claim 1, wherein:
limiting the output of the air conditioner is configured by stopping the air conditioning; and
relaxing the limitation on the output of the air conditioner is configured by shortening stop duration of the air conditioning as compared with the case where the vehicle is traveling in the manual driving mode.

3. The in-vehicle device according to claim 2, wherein the relaxing the limitation on the output of the air conditioner includes determining the stop duration to be shorter as the output of the air conditioner is higher.

4. The in-vehicle device according to claim 1, wherein:
limiting the output of the air conditioner is configured by limiting an output amount of the air conditioner; and
relaxing the limitation on the output of the air conditioner is configured by relaxing the limitation on the output amount of the air conditioner as compared with the case where the vehicle is traveling in the manual driving mode.

5. The in-vehicle device according to claim 1, wherein relaxing the limitation on the output of the air conditioner includes prohibiting the limitation on the output of the air conditioner in a case where the output of the air conditioner exceeds a threshold value.
